(19) United States
(12) Patent Application Publication
(10) Pub. No.: US 2007/0048202 A1
(43) Pub. Date: Mar. 1, 2007

(54) Chemical hydrogen generating device

(76) Inventors: Francis Giroux, Queensbury, NY (US); Milton Archolecas, (US)

Correspondence Address: LAW OFFICE OF MAI VU PARE, 9107 WILSHIRE BLVD. #450, BEVERLY HILLS, CA, 90210, US

(21) Appl. No.: 11/209,222

(22) Filed: Aug. 23, 2005

(51) Int. Cl. B01J 8/08; B32B 27/04

(52) U.S. Cl. 422/232; 422/112

(57) ABSTRACT

The present invention relates to a device used to produce hydrogen gas that is fueled by abundant and readily available materials and is capable of being fully manual. The present invention operates on principles of pressure created from gas production and removal of gas produced.

### FIELD OF INVENTION

This invention relates to a device that produces hydrogen gas.

### BACKGROUND OF INVENTION

Hydrogen gas is a fuel source that can eventually reduce our dependence on fossil fuel sources. It is well known in the art that a metal and a basic solution can react to form hydrogen gas. Prior art hydrogen generator devices, while incorporating this reaction, are generally complex and expensive to manufacture. Prior art devices can also be difficult to operate and are not typically suitable for residential purposes and use by laypersons.

U.S. Pat. No. 6,866,756, titled “Hydrogen Generator for Uses in a Vehicle Fuel System”, discloses a complex system in which water is electrolyzed into hydrogen gas and oxygen gas, for use in an automotive system. The patent teaches a hydrogen gas generating device for purposes of powering an automotive vehicle and requires an external energy source that is high enough to electrolyze water.

U.S. Pat. No. 6,607,703 titled “Hydrogen Generator Hydrocarbon type Fuel Combustion” discloses a system in which the combustion of hydrocarbons is used for the vaporization of water and production of hydrogen gas. The patent teaches a device that is complicated to manufacture and also requires an external energy source to combust hydrocarbons in order to generate hydrogen gas.

U.S. Pat. No. 6,800,258 titled “Apparatus for Producing Hydrogen” discloses a system in which hydrogen gas is produced by reacting aluminum with water in the presence of sodium hydroxide as a catalyst. The invention requires the use of a timer mechanism to control the operation of the device and production of hydrogen gas.

It is an object of the present invention to provide for a hydrogen generating device that is relatively inexpensive to manufacture.

It is also an object of the present invention to provide a hydrogen generating device that is fueled by inexpensive and abundant fuel materials.

Another object of the present invention is to provide a hydrogen generating device that is easy for the layperson and non-scientist to use and can be portable.

Furthermore, it is an object of the present invention to provide for a hydrogen generating device that is capable of being fully manual, yet can also incorporate external energy sources to optimize production.

### SUMMARY OF INVENTION

The present invention is a fully manual, automatic pressure driven device capable of generating hydrogen gas through the reaction of a metal in the presence of a liquid.

### BRIEF DESCRIPTION OF DRAWINGS

FIG. 1 is a cross sectional, side planar view of the hydrogen generating device.

FIG. 2 is a side planar view of the hydrogen generating device at equilibrium.

FIG. 3 is a side planar view of the hydrogen generating device in production mode.

### DETAILED DESCRIPTION OF THE PREFERRED EMBODIMENT

A preferred embodiment of the present invention will be described below. It should be appreciated that variations to the following description may be made to the device, and still fall within the spirit of the invention and the scope of protection granted by this patent.

In a preferred embodiment of the invention, aluminum is reacted with a NaOH solution. It should be noted however that various metals can be used to produce hydrogen gas in the present invention, including magnesium, manganese, and zinc. In addition, potasium, barium, strontium, and calcium may be used with the present invention and reacted with water, to also produce hydrogen gas. Because aluminum and NaOH are readily available to laypersons, they are ideal compounds to fuel the production of hydrogen gas in the present invention. Aluminum can be purchased at convenience and grocery stores in sheets as foil or recycled from soda cans. NaOH solution is commonly known as “lye” in household stores.

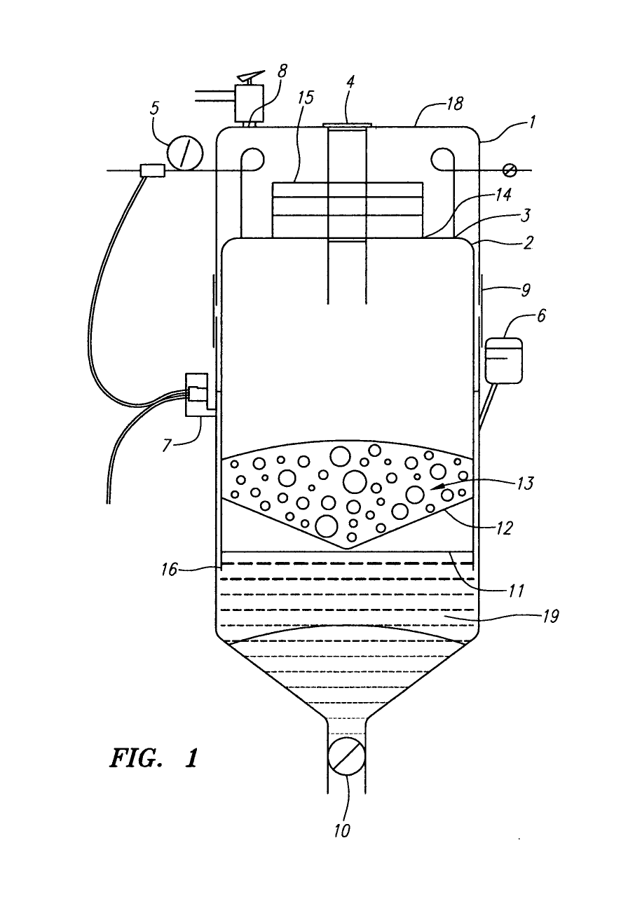

As shown in FIG. 1, the present invention is comprised of at least two compartments, with one compartment being larger 1 and a smaller compartment 2 being contained within the larger compartment. The larger compartment will be referred to hereinafter as the external compartment 1, and the smaller compartment will be referred to hereinafter as the internal compartment 2.

The top end of the internal compartment has the ability to form an airtight chamber when hydrogen gas is not being removed from the device. The two compartments are in communication through at least one opening which may include a hydrogen output opening 3 and an opening that allows for the replenishment of metal 4.

The external compartment may contain additional openings that allow various functions to take place within the device. The external compartment may include an opening for a pressure gauge to be fitted for reading the pressure within the internal compartment 5.

An opening may be provided to allow for the maintenance of the water level within the compartments 6. This opening may be comprised of a container that can be filled with water or solution which the user can manually open for the release of solution within the internal and external compartments.

Alternatively, an opening may be provided to include a means in which the water levels can be maintained automatically 7. A float switch is one such means and is well understood in the art. A float switch can be installed so that when the water level falls below a specified level, a current is connected which in turn powers a switch resulting in additional water being supplied to the system.

An opening may be provided to allow for pressure relief in the event of over production of gas 8.

An opening may be provided to allow for a rubber coupling that will pop off in the event the pressure within the external compartment exceeds the resistance of the coupling 9.

The bottom of the external compartment may provide for a drain 10 in which solid waste products may be removed.

The internal compartment 2 is where reaction between aluminum and NaOH solution occurs. The internal compartment floats above the NaOH solution 11, and is able to move horizontally and vertically within the external compartment. The top portion of the internal compartment may be airtight when the hydrogen release valve 3 is not opened. The NaOH solution 11 closes off the opposite end of the internal compartment

At the lower end of the internal compartment is an inverted, conical shaped screen 12. The screen can be removed and adjusted to different positions within the internal compartment. Said screen is used to hold aluminum pieces 13 and other scrap metal that will be used to fuel hydrogen production. While a flat screen may also be used, in a preferred embodiment of the invention, the screen has an inverted, conical shape in order to optimize termination of hydrogen production, which will be discussed in further detail below.

The topmost end of the external compartment 18 contains a sealed ring 4 that enables the user to access the screen portion of the internal compartment. The opening is closed off during hydrogen production and when open, enables the user to supply more aluminum to the reaction region of the device.

Both the internal and external compartments should be constructed from at least 316 stainless steel grade or higher, or any other metal that will not react with the NaOH solution.

### Details of Operation

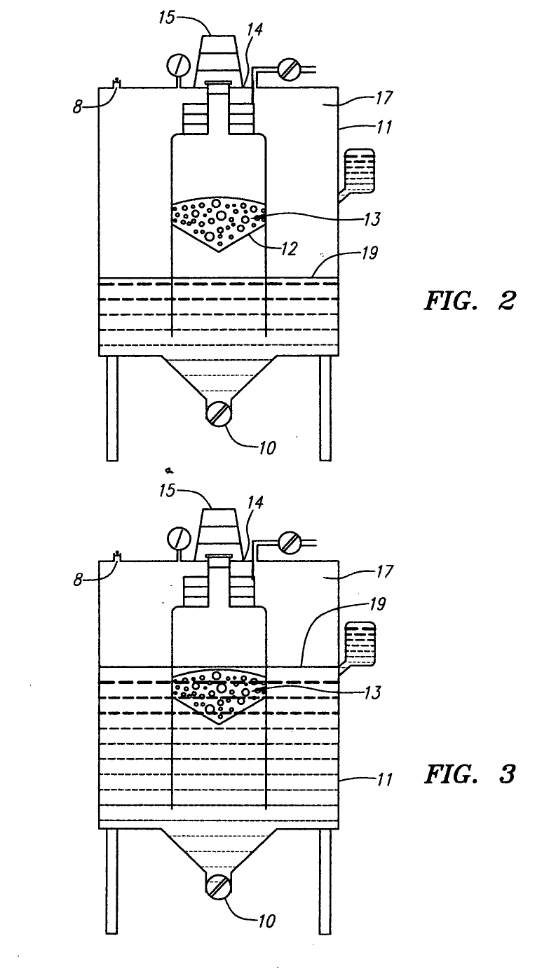

The present invention allows for a fully manual means of producing hydrogen gas. The inverse relationship of volume and pressure of a system is the guiding principle that is the basis of operation of the present invention. FIGS. 2-3 illustrate the mechanism of operation of the present invention as follows: Aluminum 13 or other suitable metal is placed on the screen contained within the internal compartment 2. NaOH solution 11 or other suitable basic solution is placed within the two compartments. FIGS. 1 and 2 show the present invention at equilibrium. At equilibrium, the screen 12 is above the NaOH solution line 19 and aluminum is not in contact with the NaOH solution.

When hydrogen gas is drawn from the hydrogen output opening 3, the pressure within the internal compartment is lowered. FIG. 3 depicts how the reduced pressure of the internal compartment results in the upward movement of the NaOH solution line 19 within the internal compartment and simultaneous lowering of the internal compartment. Said movement of the NaOH solution 11 and internal compartment 2 brings the aluminum 13 in contact with the solution, allowing the two compounds to react, producing hydrogen gas.

As the solution remains in contact with the aluminum, hydrogen gas is produced and the pressure above the solution within the internal compartment is increased. As the pressure within the internal compartment increases, the solution within the internal compartment is pushed downward, and the internal compartment is moved upward until the screen is no longer in contact with the solution as shown in FIG. 2.

As the screen is separated from the solution, the reaction between the aluminum and the solution is slowed down until the remaining solution covering the aluminum pieces has reacted. The conical shape of the screen 12 improves the draining of the aluminum pieces from the solution when hydrogen is no longer needed, increasing the speed in which the reaction is terminated.

Above the internal compartment is a weight compartment 14 where weights can be added. The weights 15 placed within the weight compartment can be increased or decreased depending on the volume of hydrogen gas desired by the user. If more hydrogen gas is desired, more weight is added to the weight compartment. Thus, when hydrogen gas is produced with additional weight added to the weight compartment 14, more hydrogen gas will need to be produced in order to push down on the NaOH solution and move the internal container away from the NaOH solution. If less gas is needed, weight is removed from weight compartment, resulting in the NaOH solution being pushed down more easily when the device is in production mode.

When aluminum reacts with the NaOH solution to release hydrogen, the aluminum is oxidized. Complete oxidation of the aluminum will give AlO₃ which is a white solid. Incomplete oxidation will give Al(OH)₃ or some other intermediate compound or unstable radical, which will be a black color. The black ash may continue to oxidize when left in contact with the solution if certain temperatures are maintained. When the aluminum pieces are oxidized to the point oxide pieces are broken off, solid material will fall through the screen 12 into the bottom of the external container where they can be removed through the drain 10.

The bottom most portion of the screen 16 is not flush with the end of the internal compartment. Referring to FIG. 1 again, it can be seen how the internal compartment floats within the external compartment At equilibrium, the lowermost end of the internal compartment 16 is slightly below the NaOH solution line 19. If the screen were to be placed flush with the bottom of the internal compartment, reaction would continually take place, and there would be no means of stopping the reaction without relying on an external power source to completely separate the internal compartment from the NaOH solution line. It is to be emphasized that the present invention is capable of operating fully manually, with no dependence on any external energy source, since there are no externally powered moving parts.

The downward movement of the NaOH solution and corresponding upward movement of the internal compartment is gradual. Providing a greater distance between the end of the internal compartment and the screen allows for quicker termination of the reaction when hydrogen gas is no longer needed because the aluminum and the screen will be removed from the solution sooner.

As the internal compartment moves upward, and solution is pushed away from the screen, hydrogen gas may continue to be produced due to some wet aluminum pieces continuing to react with solution. This may result in some hydrogen gas bubbling from the bottom of the internal compartment and entering the intermediate space between the external compartment and the internal compartment 17. This gas will create some pressure within the space between the external compartment and internal compartment

Because the movement of the internal compartment is entirely dependent on the pressure conditions of the entire system, in order to operate properly, there should be no interference from pressure created in the intermediate space 17 between the external compartment and the internal compartment. As a result, in order for the internal compartment to move based on hydrogen production needs, this intermediate space 17 should always be at low pressure. For this reason, an opening 8 in the external compartment is provided to allow for the release of this waste gas.

Thus the production of hydrogen gas is controlled according to the removal of hydrogen gas from the internal compartment and the amount of weight placed above the internal compartment. Metal and solution must continually be replenished when all has reacted in the system.

In summary, the above hydrogen generating device is a low cost, potentially portable, hydrogen generating device that has many applications for use on both a commercial and residential level. With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention.

1. A device for producing hydrogen gas, comprising:
an external compartment containing a solution;
an internal compartment contained within said external compartment capable of having an airtight top end and means for removal of hydrogen gas;
a means to contain metal within said internal compartment for placement of a metal; and
a means of attaching weight to the internal compartment whereby the pressure of gas to be produced can be regulated.

2. The device as claimed in claim 1 wherein said internal compartment and said external compartment are in communication in more than one point.

3. The device as claimed in claim 2 wherein said external and internal compartments contain openings to provide for a means of measuring pressure within said internal compartment.

4. The device as claimed in claim 2 wherein said external compartment contains a means of maintaining water levels within said internal and external compartments.

5. The device as claimed in claim 2 containing a primary means to relieve pressure within the external compartment.

6. The device as claimed in claim 5 containing a secondary means to relieve pressure within the intermediate space in the event said primary means in claim 5 fails to relieve pressure.

7. The device as claimed in claim 1 wherein a means is provided to remove solid waste product.
